(19) United States
(12) Patent Application Publication
(10) Pub. No.: US 2004/0115381 A1
(43) Pub. Date: Jun. 17, 2004

(54) Method for manufacturing articles with materials containing tapered polymers

(75) Inventors: Justin L. Harris, Bartlesville, OK (US); Shawn R. Kennedy, Ankorage, AK (US); Jianxin J. Kuang, Sunnyvale, CA (US); Mark Hanes, Winona Lake, IN (US); William W. Potter, Kingwood, TX (US); Nathan E. Stacy, Bartlesville, OK (US); Lee A. Carvell, Bartlesville, OK (US); Timothy E. Rigdon, Caney, KS (US); Larry L. Nash, Bartlesville, OK (US)

Correspondence Address: CHEVRON PHILLIPS CHEMICAL COMPANY LP, LAW DEPARTMENT - IP, P.O BOX 4910, THE WOODLANDS, TX, 77387-4910, US

(73) Assignee: Chevron Phillips Chemical Company, LP, The Woodlands, TX

(21) Appl. No.: 10/317,491

(22) Filed: Dec. 12, 2002

(51) Int. Cl. B32B 1/08

(52) U.S. Cl. 428/36.9

(57) ABSTRACT

Embodiments include articles without plasticizers, having improved clarity, kink resistance, flexibility, melt fracture and die lines. Manufacturing may be conducted with materials comprising polymodal tapered polymers prepared from copolymerizing at least one monovinyl aromatic monomer and at least one conjugated diene monomer followed by coupling with at least one coupling agent.

### FIELD OF THE INVENTION

The invention relates to articles and associated methods and applications of materials containing tapered polymers, such as tapered block polymers, prepared from at least one monovinyl aromatic monomer and at least one conjugated diene monomer.

### BACKGROUND

Flexible poly(vinyl chloride) (PVC) tubing has been widely used for many different applications, including food processing and medical uses. Due to the rigid structural and physical properties of PVC, plasticizers are required to reduce its hardness if the article, such as a piece of tubing, needs to be flexible for its application. As a result, there is a concern that plasticizers such as di-2-ethylhexyl phthalate may migrate out of the PVC into the fluid being stored in or transported through the article. Plasticizers may also migrate to the surface of an article to cause some nuisance even if contamination of another material is not a major concern. In addition, the plasticizers themselves may pose some health concerns in general.

Another consideration is related to disposal of waste or discarded materials. It is becoming increasingly desirable to use polymers that do not produce any or significant amounts of potentially toxic decomposition products such as hydrochloric acid (HCI) when the articles are incinerated or otherwise combusted either on purpose or accidentally. As a result, it can be preferable to use polymers that contain only carbon and hydrogen (and optionally oxygen) for the intended applications provided that it is possible to produce the articles with acceptable or similar properties. Certainly it is even more desirable that the new materials can impart superior properties to the finished goods or articles.

It is also recognized more specifically that it is difficult to produce tubing, particularly clear, kink-resistant, low melt-fracture and low die-line, small diameter tubing with conventional styrene-butadiene block copolymers.

There is a need in the art for processes and materials designed to accommodate considerations including the foregoing.

### SUMMARY

In some cases it may be desirable to be able to manufacture articles with a material that contains carbon and hydrogen (optionally oxygen) only, wherein at the same time such articles, particularly extruded tubings, are flexible, clear, kink resistant, and have low melt fracture and low die line without the need of using either external plasticizers or post-production heat treatment.

In the context of the present invention as it relates to flexible tubing, the term “flexible” refers generically to tubing that is freely pliable by hand, such as tubing that is flexible enough that its shape can be substantially deformed by the force of gravity. The term “kink resistant” is a relative term referring to the degree to which a tube can be bent before the walls of the tube collapse. Kink resistance is generally a product of factors including tube diameter, wall thickness, and radius of curvature. For example, in this context kink resistance could be arbitrarily defined for reference as the ability of a hollow tube to be placed in a circular shape with opposite ends abutting without having the walls of the tube collapse, wherein the span of the tube for such a determination is on the order of about 10 times the outer diameter of the tube.

Such articles can be manufactured with polymodal tapered copolymers, such as tapered block polymers prepared from copolymerization of at least one monovinyl aromatic monomer, such as styrene, at least one conjugated diene, such as 1,3-butadiene, followed by a coupling reaction with at least one coupling agent. As discussed herein, the clarity, kink-resistance, melt fracture and die line can be improved over those articles made of non-tapered block copolymers prepared from the same monovinyl aromatic monomers, conjugated dienes, and coupling agent.

In one aspect, the invention provides a method for making an article, comprising at least the following steps: (1) preparing a material which comprises at least one polymodal tapered block copolymer containing (i) at least one monovinyl aromatic monomer, (ii) at least one conjugated diene, and (iii) at least one coupling agent; (2) producing the article with the material from a machine without using an external plasticizer; and (3) collecting the article.

As examples, the monovinyl aromatic monomer can be selected from the group consisting of styrene, 2-methylstyrene, 3-methylstyrene, 4-methylstyrene, α-methylstyrene, 2-ethylstyrene, 3-ethylstyrene, 4-ethylstyrene, 4-n-propylstyrene, 4-isopropylstyrene, 4-t-butylstyrene, 4-isobutylstyrene, 4-n-butylstyrene, 2,4-dimethylstyrene, 4-(4-phenyl-n-butyl)styrene, 4-cyclohexylstyrene, 4-dodecylstyrene, 4-p-tolylstyrene, 1-vinylnaphthalene, 2-vinylnaphthalene, 9-vinylanthracene, and mixtures thereof. In some embodiments, the monovinyl aromatic monomer consists essentially of styrene, and the conjugated diene consists essentially of 1,3-butadiene.

As examples, the conjugated diene can be selected from the group consisting of 1,3-butadiene, isoprene, 1,3-pentadiene, 1,3-hexadiene, 2,4-hexadiene, 2-ethyl-1,3-butadiene, 2,3-dimethylbutadiene, 2,5-dimethyl-2,4-hexadiene, cyclopentadiene, 1-methylcyclopentadiene, 2-methylcyclopentadiene, 3-methylcyclopentadiene, and mixtures thereof.

In some embodiments, at least one of the polymodal tapered block copolymers used is selected from the group consisting of double-tapered, triple-tapered, one higher-level tapered block copolymer, and mixtures thereof. As an example, the polymodal block copolymer can comprise at least one triple-tapered block copolymer and contains at least 70% by weight of styrene.

In some embodiments, the coupling agent can be selected from the group consisting of divinylbenzene, dimethyl glutarate, dimethyl adipate, glycerol triacetate, epoxidized vegetable oils, and mixtures thereof. Similarly, the randomizing agent can be selected from the group consisting of dimethyl ether, methyl ethyl ether, diethyl ether, methyl propyl ether, ethyl propyl ether, tetrahydrofuran (THF), dioxane, tetrahydropyran, anisole, diphenyl ether, 1,2-dimethoxyethane, crown ethers, dimethyl sufide, diethyl sulfide, and mixtures thereof.

In some embodiments, the articles produced under such methods can be bondable by a solvent, heat, pressure, microwave, or ultrasound. As examples, where a bonding solvent is used, the solvent can be is selected from the group consisting of acetone, methyl ethyl ketone, methyl isobutyl ketone, chloroform, and mixtures there of.

In some embodiments, the materials produced under the invention can further comprise a polymeric blending component selected from the group consisting of polystyrene, high impact polystyrene, poly (methyl methacrylate), poly (styrene-acrylonitrile), and mixtures thereof. In some cases, the polymeric blending component can consist solely of polystyrene (e.g., present in the range of from about 10 wt % to about 70 wt % of the total weight of the material).

As previously discussed, such materials can be used to form a clear, flexible tubing by methods known in the art such as extrusion and pultrusion. In some embodiments, such materials are characterized in that a Shore Hardness of such materials is at least 80.

Other aspects of the invention will become apparent from review of the detailed description and the claims.

### DETAILED DESCRIPTION OF THE INVENTION

One embodiment of the present invention relates to a method of making articles, such as flexible small inner diameter tubing, from a material comprising one or more tapered copolymers as well as the articles such as tubing prepared thereby. In various embodiments made possible under the invention, such articles can be made without the need of using plasticizers.

For example, tubing that can be produced without the need of using plasticizers can have inside diameters in the range of from about 0 mm (if 0, the product is a rod) to about 60 mm, such as from about 0.5 mm to about 15 mm; outside diameter (o.d.) in the range of from about 0.5 mm to about 75 mm, or from about 1 mm to about 25 mm; the corresponding wall thickness in the range of from about 0.5 mm to about 10 mm, such as from about 1 mm to about 6 mm. Such tubing generally provides improved kink resistance, clarity, melt fracture and die line properties, and can be produced by traditional techniques including extrusion and pultrusion.

Small diameter flexible cables or wires with good kink resistance and improved melt fracture and die line properties may also be produced under the invention.

Once an article is produced, it can be collected, or in the alternative it can be subjected to further processing before or after collection. Suitable methods of collections are well known in the art, including extrusion and pultrusion processes. For example, in one method of producing and collecting flexible tubing under the invention, the tubing is extruded into a water bath and pull out of the bath across a forced air stream where it is dried. While not required, many different types of additional processing can be carried out as desired. Examples include heat treatment, pressure treatment, solvent bonding, polishing, and others and combinations thereof.

One advantage of the present invention is that articles can be prepared that are easily bondable to other objects through a number of techniques known in the art, such as those involving solvents, heat, pressure, microwave, or ultrasound. In particular, it may be desirable to bond articles under the present invention, such as tubing, to other articles (e.g., medical containers and devices) made from a similar material. Such bonds may generally be more robust than bonds between dissimilar materials, and can alleviate concerns such as materials (e.g., plasticizers) leaching from one material through the bond into another material that is dissimilar (e.g., does not contain plasticizers). In general, it will be appreciated that such leaching of plasticizers and other polymer components may lead to degradation of the materials involved. Still, in other embodiments where this consideration is of less concern, articles under the present invention can be bonded to dissimilar materials.

Some examples of a suitable solvent for bonding include, but are not limited to, oxygenated solvents like acetone, methyl ethyl ketone, methyl isobutyl ketone, methyl t-butyl ether (MTBE), 1,3-dioxane, 1,4-dioxane, tetrahydrofuran (THF), tetrahydropyran; halogenated solvents like methylene chloride, chloroform, 1,2-dichloroethane; aromatic solvents like benzene, toluene, ethylbenzene, o-xylene, m-xylene, p-xylene; and other solvents known to soften the styrene-butadiene block copolymer containing materials; and mixtures thereof.

Tapered block copolymers under the invention are generally polymodal, and coupled with coupling agents. The term “polymodal” is used to describe a copolymer product having two or more molecular weight distribution curves, distinguishable or identifiable by various analytical techniques such as gel permeation chromatography. Depending on the reaction parameters and the monomers/initiator/coupling agents selected, there may be different degrees of overlap among the molecular weight distributions.

As examples, tapered copolymers have been generally described in U.S. Pat. Nos. 5,130,377, 5,705,569, 6,096,828, and application Ser. Nos. 09/576,408 and 09/576,879. For further reference, these patents are hereby incorporated herein by reference. The same meanings of the terms—non-tapered, single-tapered, double-tapered, triple-tapered, and higher level (such as quadruple- etc.) tapered—are used herein. The terms “monovinylarene monomer” and “monovinyl aromatic monomer” are used interchangeably.

Below is a narrative and generic description of the preparation of non-tapered, single-tapered, double tapered, and triple tapered block copolymers. Styrene (S) and butadiene (B) are used as illustrative monomers for monovinyl aromatic monomer and conjugated diene respectively. The terms “copolymer” and “copolymerization” are used herein to indicate there are two or more different monomers in the product or the polymerization process. An epoxidized soybean oil is used as the coupling agent (x) in the examples. Because many of the initiators contain lithium as the cation, “Li” is used to represent the initiator. However, initiators containing other metals such as Na, K, Rb, Cs or mixtures of alkali metals can be used as well. The subscripts are used to distinguish the monomer or initiator charged at different stages of the polymerization process. All of the “S” charges (S1, S2, etc) may be the same or different monovinyl aromatic monomer or monomer mixtures. Similarly, all of the “B” charges may be the same or different conjugated diene or diene mixtures. Also similarly, the same or different initiator or initiator mixtures may be used for different charges. More detailed descriptions of the preparation can be found in the incorporated portions of the cited references herein.

Non-tapered (multi-) block copolymer (SB-x-BS type copolymers)

SB represents a single or two or more blocks, depending on how many times the individual polymerization steps, (3) and (4) below, have been repeated.

A typical non-tapered single-block reaction with coupling can involve the following steps:

(1) A solvent (such as cyclohexane) is added into the reactor, a randomizer (such as THF) is added,

(2) an initiator (Li1 such as n-butyl lithium) charge is added,

(3) a styrene (S1) charge is added, and allowed to reach a peak temperature and cool down,

(4) a butadiene (B1) charge is added quickly and completely, and allowed to reach a peak temperature, and

(5) a coupling agent, x, such as epoxidized soybean oil is added after the temperature peak is seen.

Single-Tapered Block Copolymer

A typical reaction can involve the following steps:

(1) A solvent (such as cyclohexane) is added into the reactor, a randomizer (such as THF) is added,

(2) a first initiator charge (Li1) is added,

(3) a first styrene charge (S1) is added, and allowed to reach a peak temperature and cool down,

(4) a second initiator charge (Li2) is added,

(5) a second styrene charge (S2) is added and allowed to reach a peak temperature and cool down,

(6) the tapered segment is charged, with both styrene (S3) and butadiene (B) added quickly and completely, then allowed to reach a peak temperature. The reactor is not cooled after this charge, and

(7) a coupling agent (x) is added after the temperature peak is seen.

Double-Tapered Block Copolymer

A typical reaction can involve the following steps:

(1) A solvent (such as cyclohexane) is added into the reactor, a randomizer (such as THF) is added,

(2) a first initiator charge (Li1) is added,

(3) a first styrene charge (S1) is added, and allowed to reach a peak temperature and cool down,

(4) a second initiator (Li2) charge is added,

(5) a second styrene charge (S2) is added and allowed to reach a peak temperature and cool down,

(6) the first tapered segment is charged, with both styrene (S3) and butadiene (B1) added quickly and completely, and allowed to reach a peak temperature and cool,

(7) the second tapered segment is charged, with both styrene (S4) and butadiene (B2) added quickly and completely, and allowed to reach a peak temperature. The reactor is not cooled after this charge, and

(8) a coupling agent (x) is added after the temperature peak is seen.

Triple-Tapered Block Copolymer

A typical reaction can involve the following steps:

(1) A solvent (such as cyclohexane) is added into the reactor, a randomizer (such as THF) is added,

(2) a first initiator charge (Li1) is added,

(3) a first styrene charge (S1) is added, and allowed to reach a peak temperature and cool down,

(4) a second initiator (Li2) charge is added,

(5) a second styrene charge (S2) is added and allowed to reach a peak temperature and cool down,

(6) the first tapered segment is charged, with both styrene (S3) and butadiene (B1) added quickly and completely, and allowed to reach a peak temperature and cool down,

(7) the second tapered segment is charged, with both styrene (S4) and butadiene (B2) added quickly and completely, and allowed to reach a peak temperature and cool,

(8) the third tapered segment is charged, with both styrene (S5) and butadiene (B3) added quickly and completely, and allowed to reach a peak temperature. The reactor is not cooled after this charge, and

(9) a coupling agent (x) is added after the temperature peak is seen.

Higher level or order tapered copolymers, such as quadruple tapered, quintuple tapered, or others may be similarly prepared by extending the steps prior to addition of the coupling agents. It may be critical that at each stage, all the monomers should be allowed to be substantially depleted, e.g., reacted, before the next stage is started. In the end, essentially all of the charged monovinyl aromatic monomer(s) and conjugated diene(s) are incorporated into the final polymer products.

It should also be noted that there are two consecutive charges of styrene (as a monovinyl aromatic monomer) with additional initiator added between the two charges at the beginning for all the tapered copolymer examples here. A single charge of initiator and single charge of styrene or three or more charges of initiator and three or more charges of styrene would also be within the scope of the present invention. When two or more consecutive charges of monovinyl aromatic monomer are used in accordance with this invention, the copolymers would possess a polymodal molecular weight distribution. It is also within the scope of the present invention to charge more initiators at other stages along with the various tapered segment charges.

Once the copolymerization and coupling reaction are completed, the product can be isolated or recovered or purified by methods known in the art. As discussed in more detail later, it may be desired to “fix” or otherwise deactivate the more reactive carbon anions with an active —OH containing compound or CO2.

Examples of monovinyl aromatic monomers suitable for preparing the various tapered block copolymers include, but are not limited to, styrene, 2-methylstyrene, 3-methylstyrene, 4-methylstyrene, α-methylstyrene, vinyltoluenes (mixtures of various methylstyrenes), 2-ethylstyrene, 3-ethylstyrene, 4-ethylstyrene, 4-t-butylstyrene, 4-isopropylstyrene, 2,4-dimethylstyrene, 2-ethyl-4-benzylstyrene, 4-(4-phenyl-n-butyl)styrene, 4-cyclohexylstyrene, 4-dodecylstyrene, 4-p-tolylstyrene, 1-vinyinaphthalene, 2-vinylnaphthalene, 9-vinylanthracene, and mixtures thereof. Many other substituted styrenes may also be used. Examples are 3-t-butylstyrene, 3-isopropylstyrene, 4-isobutylstyrene, 3-isobutylstyrene, 4-n-propylstyrene, 4-n-butylstyrene, 4-phenylstyrene, etc. If they contain heteroatoms (e.g., all those except carbon, hydrogen and oxygen), there will be various decomposition products containing these heteroatoms. The amount of such monovinyl aromatic monomer is typically greater than about 60%, by weight, in the tapered block copolymers.

Examples of conjugated dienes (as monomer) suitable for preparing various tapered block copolymers include, but are not limited to 1,3-butadiene, isoprene, 1,3-hexadiene, 2,4-hexadiene, 2-ethyl-1,3-butadiene, 2,3-dimethylbutadiene, 1,3-pentadiene, piperylene (pentadiene isomer mixtures), 2,5-dimethyl-2,4-hexadiene, and mixtures thereof.

As examples, the total amount of the conjugated diene(s) in the tapered block copolymer can be present in ranges, including from about 20 wt % to about 50 wt %, from about 30 wt % to about 45 wt %, or from about 34 wt % to about 42 wt %. The balance is essentially the total amount of the monovinyl aromatic monomer(s). Additional information regarding the ranges of various amounts is disclosed in the examples below. The relative amounts of the conjugated dienes and monovinyl aromatic monomers may be varied or adjusted for different stages of the copolymerization to produce the desired degree of tapering.

The following tables, Tables 1-4, show reaction parameters performed according to the teachings of U.S. Pat. No. 5,705,569.

TABLE 1
Ranges Of Amounts Of Components In Embodiment A^{a}

| Step | Component | Range A^{b} | Range B^{b} | Range C^{b} |
|---|---|---|---|---|
| (a) | Randomizer^{c} | 0.001-3.0 | 0.01-1.0 | 0.02-0.5 |
| | Initiator | 0.001-0.20 | 0.005-0.10 | 0.01-0.07 |
| | and | | | |
| | Monovinylaromatic | 32-48 | 35-45 | 38-42 |
| | monomer | | | |
| (b) | Initiator | 0.001-0.20 | 0.005-0.10 | 0.01-0.07 |
| | and | | | |
| | Monovinylaromatic | 12-28 | 15-25 | 18-22 |
| | monomer | | | |
| (c) | Initiator | 0.001-0.20 | 0.005-0.15 | 0.01-0.12 |
| | and | | | |
| | Monovinylaromatic | 6-14 | 8-12 | 9-11 |
| | monomer | | | |
| (d) | Monovinylaromatic | 5-25 | 10-20 | 13-17 |
| | monomer | | | |
| | and | | | |
| | Conjugated diene | 5-25 | 10-20 | 13-17 |
| | monomer | | | |
| (e) | Coupling agent | 0.15-0.35 | 0.18-0.32 | 0.20-0.30 |

^{a}Monomers within each charge having more than one monomer can be added simultaneously or as a mixture, slowly or quickly. Randomizer in charge (a) may be already present in a diluent or added as a separate charge.
^{b}Ranges of amounts are given in parts by weight per 100 parts by weight of total monomers (phm).
^{c}To achieve significant tapering, up to 3 phm randomizer may be used.

TABLE 2
Ranges Of Amounts Of Components In Embodiment B^{a}

| Step | Component | Range A^{b} | Range B^{b} | Range C^{b} |
|---|---|---|---|---|
| (a) | Randomizer^{c} | 0.001-3.0 | 0.01-1.0 | 0.02-0.5 |
| | Initiator | 0.001-0.20 | 0.005-0.10 | 0.01-0.07 |
| | and | | | |
| | Monovinyl | 32-48 | 35-45 | 38-42 |
| | aromatic | | | |
| | monomer | | | |
| (b) | Initiator | 0.001-0.20 | 0.005-0.10 | 0.01-0.07 |
| | and | | | |
| | Monovinyl | 12-28 | 15-25 | 18-22 |
| | aromatic | | | |
| | monomer | | | |
| (c) | Initiator | 0.001-0.20 | 0.005-0.15 | 0.01-0.12 |
| | and | | | |
| | Monovinyl | 6-14 | 8-12 | 9-11 |
| | aromatic | | | |
| | monomer | | | |
| (d) | Monovinyl | 6-14 | 8-12 | 9-11 |
| | aromatic | | | |
| | monomer | | | |
| (e) | Coupling agent | 0.15-0.35 | 0.18-0.32 | 0.20-0.30 |

^{a}Monomers within each charge having more than one monomer can be added simultaneously or as a mixture, slowly or quickly. Randomizer in charge (a) may be already present in a diluent or added as a separate charge.
^{b}Ranges of amounts are given in parts by weight per 100 parts by weight of total monomers (phm).
^{c}To achieve significant tapering, up to 3 phm randomizer may be used.

TABLE 3
Ranges Of Amounts Of Components In Embodiment C^{a}

| Step | Component | Range A^{b} | Range B^{b} | Range C^{b} |
|---|---|---|---|---|
| (a) | Randomizer^{c} | 0.001-3.0 | 0.01-1.0 | 0.02-0.5 |
| | Initiator | 0.001-0.20 | 0.005-0.10 | 0.01-0.07 |
| | and | | | |
| | Monovinyl | 32-48 | 35-45 | 38-42 |
| | aromatic | | | |
| | monomer | | | |
| (b) | Initiator | 0.001-0.20 | 0.005-0.10 | 0.01-0.07 |
| | and | | | |
| | Monovinyl | 12-28 | 15-25 | 18-22 |
| | aromatic | | | |
| | monomer | | | |
| (c) | Initiator | 0.001-0.20 | 0.005-0.15 | 0.01-0.12 |
| | and | | | |
| | Monovinyl | 6-14 | 8-12 | 9-11 |
| | aromatic | | | |
| | monomer | | | |
| (d) | Monovinyl | 5-25 | 10-20 | 13-17 |
| | aromatic | | | |
| | monomer | | | |
| | and | | | |
| | Conjugated | 5-25 | 10-20 | 13-17 |
| | diene | | | |
| | monomer | | | |
| (e) | Coupling | 0.15-0.70 | 0.18-0.60 | 0.20-0.50 |
| | agent | | | |

^{a}Monomers within each charge having more than one monomer can be added simultaneously or as a mixture, slowly or quickly. Randomizer in charge (a) may be already present in a diluent or added as a separate charge.
^{b}Ranges of amounts are given in parts by weight per 100 parts by weight of total monomers (phm).
^{c}To achieve significant tapering, up to 3 phm randomizer may be used.

TABLE 4
Ranges Of Amounts Of Components In Embodiment D^{a}

| Step | Component | Range A^{b} | Range B^{b} | Range C^{b} |
|---|---|---|---|---|
| (a) | Randomizer^{c} | 0.001-3.0 | 0.01-1.0 | 0.02-0.5 |
| | Initiator | 0.001-0.20 | 0.005-0.10 | 0.01-0.07 |
| | and | | | |
| | Monovinyl | 32-48 | 35-45 | 38-42 |
| | aromatic | | | |
| | monomer | | | |
| (b) | Initiator | 0.001-0.20 | 0.005-0.10 | 0.01-0.07 |
| | and | | | |
| | Monovinyl | 12-28 | 15-25 | 18-22 |
| | aromatic | | | |
| | monomer | | | |
| (c) | Initiator | 0.001-0.20 | 0.005-0.15 | 0.01-0.12 |
| | and | | | |
| | Monovinyl | 10-25 | 12-20 | 14-18 |
| | aromatic | | | |
| | monomer | | | |
| (d) | Monovinyl | 2-10 | 3-7 | 4-6 |
| | aromatic | | | |
| | monomer | | | |
| | and | | | |
| | Conjugated | 2-10 | 3-7 | 4-6 |
| | diene | | | |
| | monomer | | | |
| (e) | Monovinyl | 3-12 | 5-9 | 6-8 |
| | aromatic | | | |
| | monomer | | | |
| | and | | | |
| | Conjugated | 3-12 | 5-9 | 6-8 |
| | diene | | | |
| | monomer | | | |
| (f) | Coupling | 0.15-0.70 | 0.18-0.60 | 0.20-0.50 |
| | agent | | | |

^{a}Monomers within each charge having more than one monomer can be added simultaneously or as a mixture, slowly or quickly. Randomizer in charge (a) may be already present in a diluent or added as a separate charge.
^{b}Ranges of amounts are given in parts by weight per 100 parts by weight of total monomers (phm).
^{c}To achieve significant tapering, up to 3 phm randomizer may be used.

An anionic co-polymerization process to produce the block copolymers may be used in the presence of an initiator. The terms “initiator” and “catalyst” are used interchangeably herein. Some initiators contain cyclic or non-cyclic or aromatic (used interchangeably with the term “aryl”) anionic R-moieties with a suitable cation M+. Some examples of such suitable initiators include organoalkali metal compounds, such as alkyl (including cyclic alkyl) lithium compounds, alkyl sodium compounds, alkyl potassium compounds, aryl lithium compounds, and mixtures thereof. Organolithium compounds, particularly n-butyl and sec-butyl lithium, may provide advantages in ease of handling, chemical and physical properties, and commercial availabilities. While “Li” is used as a shorthand symbol for initiators herein, it is to be understood that the present invention is not limited to use of lithium based compounds or butyl lithium compounds only. In addition, it is also known that many such organolithium or other organometal compounds exist in solutions not as monomers, but as dimers, trimers, tetramers, hexamers, etc. These dimers and oligomers are also within the scope of the present invention.

The total amount of the initiator or randomizer charged and how many different charges are made and when these charges are made can greatly influence the polymodal nature and many other physical and chemical properties of the final tapered block copolymer products.

As an example, the amount of an initiator used can be in the range of from about 0.001 to about 0.20 parts per 100 parts of total weight of monomers present, all by weight. As a further example, the amount can be in the range of from about 0.005 to about 0.15 parts per 100 parts of total weight of all the monomers present, by weight. The amount, number of charges, timing of charges, and type of a selected initiator or initiators may be varied to produce the desired molecular weight, molecular weight distribution, polymodal profile and other physical and chemical properties.

Due to the highly reactive nature of the initiators, sometimes it is necessary to use more to overcome or react away the impurities present, or to purify the monomers and/or solvent, or both. It may be desirable to carry out the entire co-polymerization reaction substantially in the absence of air, water or carbon dioxide. It may be more convenient to carry out the copolymerization reaction under a blanket of nitrogen or other substantially inert atmosphere such as argon, helium, neon, krypton and mixtures thereof.

Examples of suitable randomizers include, but are not limited to, polar compounds such as ethers, thioethers (sulfides), tertiary amines, and mixtures thereof. Compounds containing active hydrogen groups (such as —OH, —SH, and —NH) in the structures are generally disfavored. Some examples of randomizers include, but are not limited to, dimethyl ether, methyl ethyl ether, diethyl ether, methyl propyl ether, ethyl propyl ether, tetrahydrofuran (THF), dioxane, tetrahydropyran, anisole, diphenyl ether, 1,2-dimethoxyethane, crown ethers, dimethyl sufide, diethyl sulfide, RaRbRcN wherein Ra, Rb, and Rc are independently selected from C1-C10 alkyl and cyclic alkyl groups tetramethylethylenediamine, tetraethylethylenediamine, N,N-dimethylaniline, N-methyl-N-ethylaniline, N-methylmorpholine, and mixtures thereof. For most common reaction conditions, the randomizer is added to the reaction mixture at the beginning of the process.

The amount of a randomizer can depend on the randomizer's structure, the monovinyl aromatic monomer(s) and the conjugated diene(s) selected, the level of tapering desired, the desired characteristics of the product, and also the intended application. As an example, the amount can be in the range of from about 0.001 wt % to about 3.0 wt %, e.g., from about 0.005 wt % to about 1.5 wt %, or from about 0.015 wt % to about 0.3 wt %, all based on the total weight of all of the monomers (aromatic and conjugated diene) to be copolymerized, e.g., weight per 100 parts by weight of total monomers.

A solvent (also referred to as hydrocarbon diluent) may be present for the copolymerization reaction, which is exothermic. There are several reasons that a solvent might be used. For instance, it can allow control of the desired concentrations of various components of the reaction, control of reaction temperature, use of a component that is not in the fluid form under reaction conditions, and recovery of the product. The solvent may also come in with commercial grades of the various components such as the initiators or coupling agents used. It may be desired to have an amount of the solvent sufficient to achieve a desired temperature profile and/or control, as well as to maintain all or as much as possible the polymer product in the solution phase without precipitating out or being separated in a different phase.

Examples of solvents can include non-polar aliphatic hydrocarbons. It may be desired that such solvents be substantially in the liquid state under the reaction conditions. It may also be desired that such solvents not participate in or otherwise interfere with the desired copolymerization reaction. It may also be desired that such solvents have low miscibilities with water. Some examples of solvents include linear or branched isomers of alkanes and cycloalkanes such as butane(s), pentane(s), hexane(s), heptane(s), octane(s), nonane(s), decane(s), cyclopentane, cyclohexane, methylcyclopentane, methylcyclohexane, and mixtures thereof.

The amount of solvent should be in the range of from 150 wt % to about 10,000 wt %, based on the total weight of all the other reactants (monovinyl aromatic monomers, dienes, initiators, randomizers, and coupling agents) present in the entire polymerization process. It is generally desirable to have sufficient solvent in the (co)polymerization reactor to keep the (co)polymer product substantially dissolved.

Suitable coupling agents must be multifunctional, e.g., they must have at least two or more reactive functional groups that are capable of reacting with the terminal or pendant functional groups, primarily carbon anions when organo alkali or alkaline earth compounds are used as initiators, of the block copolymers under suitable reaction conditions.

Examples of such reactive functional groups in the coupling agents include, but are not limited to, carbon-carbon double bonds, carbon-carbon triple bonds, carbonyl groups, epoxide groups, ester groups, anhydride groups, carboxylic acid groups, lactones, thio-epoxide groups, isocyanate groups, thiocyanate groups, aldehyde groups, carbonyl groups, imine groups, Sn—O—R groups (such as Sn—O-CH3, Sn—O-C2H5, and others), Si-halide groups (such as Si—Cl, Si—Br, Si—I and Si—F), and mixtures thereof. If there are only two coupling sites in a coupling agent, then primarily linearly coupled polymodal materials are produced.

In order to limit, reduce or eliminate production of undesired decomposition products, it may be desired to use coupling agents containing only carbon, hydrogen, and optionally oxygen in the structure. Some examples of such coupling agents include divinylbenzene, dimethyl glutarate, dimethyl adipate, glycerol triacetate, etc. Epoxidized vegetable oils (such as soybean oil, linseed oil etc) and their mixtures are often selected for their commercial availability, purity, overall properties, and price.

The total weight of coupling agent used is generally in the range of from about 0.005 to about 10 parts per 100 parts of total weight of all the monomers used for the copolymerization. It may be desired to be in the range of from about 0.2 to about 0.6, or in the range of from about 0.3 to about 0.5 parts per 100 parts of total weight of all the monomers used for the copolymerization. These ranges may depend on the number of functionalities per weight of the coupling agent. The higher this number is, the lower amount of the coupling agent would be needed.

Examples of a neutralization agent to “fix” the alkali metal ion present after the coupling reaction include OH containing compounds such as water, alcohols (methanol, ethanol, propanol and others), phenols, mono-, di-, or multi-carboxylic acids (such as acetic acid, propionic acid and others), carbon dioxide, and mixtures thereof.

Once the block copolymer is made and recovered, a material comprising the polymer or mixtures of different polymers is prepared. Depending on the desired properties of the article and other conditions, this material may or may not contain one or more other compounds or substances. Such compounds may include coloring agents, fillers, binders, anti-oxidants, stabilizers, binding agents, or one or more other polymeric blending components such as polystyrenes, high-impact polystyrenes, poly(methylstyrene), poly(methyl acrylate), poly(methyl methacrylate) (PMMA), acrylonitrile-butadiene-styrene copolymers (ABS), styrene-acrylonitrile copolymer (SAN), other styrene copolymers, polyolefins, copolymers of different olefins, polycarbonate, poly(chloroprene), and others and mixtures thereof. As already discussed, it may be desired to minimize or eliminate the use of any materials that may produce undesirable products when the article is discarded or subjected to post-use handlings such as burial, incineration, reclamation, recycling, and other methods. If there were no additional compounds added to the material, then the material would consist of or consist essentially of the polymodal tapered block copolymers themselves.

The exact amount depends on the composition and properties of the polymeric blending component(s), the intended application of the article, the processing equipment and conditions, and the desired characteristics and properties of the finished article or product. The amount of the polymeric blending component is typically in the range of from about 0.1 wt % to about 99.9 wt %, such as 1.0 wt % to about 99.0 wt %, or from 5 wt % to about 95 wt %, all based on the combined total weight of the tapered block copolymers and the polymeric blending components. More specifically, when a polymer of styrene, such as polystyrene, is used as the polymeric blending component, the range is typically from about 10 wt % to about 70 wt %, such as from about 20 wt % to about 65 wt %, or from about 30 wt % to about 60 wt %.

In one embodiment, no external plasticizers are needed or used. In other words, no plasticizers are added on purpose to the material to impart the desired flexibility or other properties to the material.

It may be desirable that formulations under the present invention provide articles with Shore Hardness values at least as high as PVC tubing, which is currently used in many tubing applications. Embodiments under the aforementioned examples can provide a Shore Hardness of at least 80.

Once a suitable material is prepared, it is sent through a machine to produce the desired article. The present invention can be applied to many different types or shapes of articles, such as tubing, strings, wires, cables, extrudates, pellets, sheets, containers, covers, plates, and many other products. The articles can be subjected to additional processing steps, such as heat treatment, as disclosed herein. Some of the products are also solvent or heat or pressure bondable articles which can be attached or bonded to articles or surfaces made of the same or different materials. Such bonding can also be achieved with ultrasound or microwave or exposures to other electromagnetic conditions by using proper devices or tools.

Depending what the article is, different processing units are used. In general, extruders, injection molding machines, blow-molding machines and/or sheet extruder are used. For tubing products, extruders and injection molding machines are typically used. These may be further combined with other additional processing steps such as solvent bonding or heat treatment to make the final product. Such additional processing steps may be carried out during or after the article is made.

The following is claimed:

1. A method for making an article, comprising:
preparing a material which comprises at least one polymodal tapered block copolymer comprising (i) at least one monovinyl aromatic monomer, (ii) at least one conjugated diene, and (iii) at least one coupling agent; and
producing the article with the material from a machine without using an external plasticizer.

2. The method of claim 1, wherein the monovinyl aromatic monomer is selected from the group consisting of styrene, 2-methylstyrene, 3-methylstyrene, 4-methylstyrene, a-methylstyrene, 2-ethyl styrene, 3-ethyl styrene, 4-ethylstyrene, 4-n-propylstyrene, 4-isopropylstyrene, 4-t-butylstyrene, 4-isobutylstyrene, 4-n-butylstyrene, 2,4-dimethylstyrene, 4-(4-phenyl-n-butyl)styrene, 4-cyclohexylstyrene, 4-dodecylstyrene, 4-p-tolylstyrene, 1-vinyinaphthalene, 2-vinyinaphthalene, 9-vinylanthracene, and mixtures thereof.

3. The method of claim 2, wherein the monovinyl aromatic monomer consists essentially of styrene.

4. The method of claim 1, wherein the conjugated diene is selected from the group consisting of 1,3-butadiene, isoprene, 1,3-pentadiene, 1,3-hexadiene, 2,4-hexadiene, 2-ethyl-1,3-butadiene, 2,3-dimethylbutadiene, 2,5-dimethyl-2,4-hexadiene, cyclopentadiene, 1-methylcyclopentadiene, 2-methylcyclopentadiene, 3-methylcyclopentadiene, and mixtures thereof.

5. The method of claim 4, wherein the conjugated diene consists essentially of 1,3-butadiene.

6. The method of claim 1, wherein at least one of the polymodal tapered block copolymer is selected from the group consisting of double-tapered, triple-tapered, one higher-level tapered block copolymer, and mixtures thereof.

7. The method of claim 1, wherein the polymodal block copolymer comprises at least one triple-tapered block copolymer and comprises at least 70% by weight of styrene.

8. The method of claim 1, wherein the coupling agent is selected from the group consisting of divinylbenzene, dimethyl glutarate, dimethyl adipate, glycerol triacetate, epoxidized vegetable oils, and mixtures thereof.

9. The method of claim 1, wherein the material further comprises a randomizing agent selected from the group consisting of dimethyl ether, methyl ethyl ether, diethyl ether, methyl propyl ether, ethyl propyl ether, tetrahydrofuran (THF), dioxane, tetrahydropyran, anisole, diphenyl ether, 1,2-dimethoxyethane, crown ethers, dimethyl sufide, diethyl sulfide and mixtures thereof.

10. The method of claim 1, wherein the article is bondable by a solvent, heat, pressure, microwave, or ultrasound.

11. The method of claim 10, wherein the solvent is selected from the group consisting of acetone, methyl ethyl ketone, methyl isobutyl ketone, chloroform, and mixtures there of.

12. The method of claim 1, wherein the material further comprises a polymeric blending component selected from the group consisting of polystyrene, high impact polystyrene, poly (methyl methacrylate), poly (styrene-acrylonitrile), and mixtures thereof; and the article is a tubing.

13. The method of claim 12, wherein the polymeric blending component consists essentially of polystyrene.

14. The method of claim 13, wherein the polystyrene is present in the range of from about 10 wt % to about 70 wt % of the total weight of the material.

15. The article prepared according to claim 1.

16. The article of claim 15, wherein the article is a clear flexible tube having a Shore Hardness of at least 80.

17. The article prepared according to claim 3.

18. The article prepared according to claim 5.

19. The article prepared according to claim 7.

20. The article prepared according to claim 12.

21. A method for making tubing, comprising:
preparing a material which comprises at least one polymodal triple-tapered block copolymer comprising (i) at least 70% by weight styrene, (ii) 1,3-butadiene and (iii) at least one coupling agent;
producing the tubing with the material from an extruding machine without using an external plasticizer; and
collecting and processing the tubing, wherein the tubing has an inside diameter smaller than about 60 mm and a wall thickness in the range of from about 0.5 mm to about 10 mm.

22. An article comprising a tapered block copolymer prepared according to the method of claim 21.

23. The article of claim 22, wherein the article has a Shore Hardness of at least 80.

24. An article prepared according to the method of claim 21.

25. The method of claim 21, wherein the step of producing the tubing with the material from an extruding machine without using an external plasticizer comprises:
extruding the tubing into a water bath;
pulling the extruded tubing from the water bath; and
drying the tubing with a forced air stream.

26. The method of claim 21, wherein at least one of the polymodal tapered block copolymer is selected from the group consisting of double-tapered, triple-tapered, one higher-level tapered block copolymer, and mixtures thereof.

27. A method for making an article, comprising:
preparing a material which comprises at least one polymodal tapered block copolymer comprising (i) at least one monovinyl aromatic monomer, (ii) at least one conjugated diene, and (iii) at least one coupling agent; and
producing the article with the material from a machine.

28. The method of claim 27, further comprising:
bonding a first article to a second article, wherein the first and second articles are each a tapered block copolymer prepared according to the method of claim 27, and wherein the first and second articles are bonded by a solvent, heat, pressure, microwave, or ultrasound.

29. An article comprising a tapered block copolymer prepared according to the method of claim 27.

30. The article of claim 29, wherein the article is a clear flexible tube having a Shore Hardness of at least 80.

31. The method of claim 27, wherein the step of collecting the article comprises:
extruding a hollow tube into a water bath;
pulling the extruded tube from the water bath; and
drying the tubing with a forced air stream.

32. The method of claim 27, wherein at least one of the polymodal tapered block copolymer is selected from the group consisting of double-tapered, triple-tapered, one higher-level tapered block copolymer, and mixtures thereof.

33. The method of claim 27, wherein the monovinyl aromatic monomer is selected from the group consisting of styrene, 2-methylstyrene, 3-methylstyrene, 4-methylstyrene, α-methylstyrene, 2-ethylstyrene, 3-ethylstyrene, 4-ethylstyrene, 4-n-propylstyrene, 4-isopropylstyrene, 4-t-butylstyrene, 4-isobutylstyrene, 4-n-butylstyrene, 2,4-dimethylstyrene, 4-(4-phenyl-n-butyl)styrene, 4-cyclohexylstyrene, 4-dodecylstyrene, 4-p-tolylstyrene, 1-vinylnaphthalene, 2-vinyinaphthalene, 9-vinylanthracene, and mixtures thereof.

34. The method of claim 27, wherein the monovinyl aromatic monomer consists essentially of styrene.

35. The method of claim 27, wherein the conjugated diene is selected from the group consisting of 1,3-butadiene, isoprene, 1,3-pentadiene, 1,3-hexadiene, 2,4-hexadiene, 2-ethyl-1,3-butadiene, 2,3-dimethylbutadiene, 2,5-dimethyl-2,4-hexadiene, cyclopentadiene, 1-methylcyclopentadiene, 2-methylcyclopentadiene, 3-methylcyclopentadiene, and mixtures thereof.

36. The method of claim 27, wherein the conjugated diene consists essentially of 1,3-butadiene.

37. The method of claim 27, wherein the at least one coupling agent is selected from the group consisting of divinylbenzene, dimethyl glutarate, dimethyl adipate, glycerol triacetate, epoxidized vegetable oils, and mixtures thereof.

38. The method of claim 27, wherein the polymodal block copolymer comprises at least one triple-tapered block copolymer and comprises at least 70% by weight of styrene.

39. The method of claim 27, wherein the material further comprises a polymeric blending component selected from the group consisting of polystyrene, high impact polystyrene, poly (methyl methacrylate), poly (styrene-acrylonitrile), and mixtures thereof; and the article is a tubing.

40. The method of claim 39, wherein the polymeric blending component consists essentially of polystyrene.

41. The method of claim 40, wherein the polystyrene is present in the range of from about 10 wt % to about 70 wt % of the total weight of the material.
